(19) United States
(12) Patent Application Publication
(10) Pub. No.: US 2024/0104448 A1
(43) Pub. Date: Mar. 28, 2024

(54) MANAGEMENT APPARATUS, MANAGEMENT METHOD, AND STORAGE MEDIUM

(71) Applicant: HONDA MOTOR CO., LTD., Tokyo (JP)

(72) Inventors: Daisuke INOUE, Tokyo (JP); Toshikatsu KURAMOCHI, Tokyo (JP)

(21) Appl. No.: 18/372,113

(22) Filed: Sep. 24, 2023

(30) Foreign Application Priority Data
Sep. 26, 2022 (JP) 2022-152062

(51) Int. Cl. G06Q 10/0631; G01C 21/34; G06Q 10/02

(52) U.S. Cl. CPC G06Q 10/0631; G01C 21/3438; G06Q 10/025

(57) ABSTRACT

A management apparatus includes: a reservation acceptance unit that selectively accepts an exclusive use reservation in which an aircraft is exclusively used by a sole reservation holder who has solely made a reservation for use of the aircraft, and a sharing reservation in which the aircraft is shared by a plurality of reservation holders; and a utilization plan formulation unit that formulates a utilization plan for the aircraft based on the result of acceptance by the reservation acceptance unit.

### CROSS-REFERENCE TO RELATED APPLICATIONS

This application is based upon and claims the benefit of priority from Japanese Patent Application No. 2022-152062 filed on Sep. 26, 2022, the contents of which are incorporated herein by reference.

### BACKGROUND OF THE INVENTION

### Field of the Invention

The present invention relates to a management apparatus, a management method, and a storage medium.

### Description of the Related Art

JP 6183970 B2 discloses a technique related to optimization of an airline on which an aircraft travels.

### SUMMARY OF THE INVENTION

In recent years, there has been an increasing effort to provide access to sustainable transport systems for all with special attention to the needs of those in vulnerable situations. In order to realize this, research and development for further improving the safety and convenience of traffic through research and development relating to sharing of aircraft have been focused on.

Relatively small aircraft (for example, four to six passenger aircraft), also referred to as business jets, are known. The business jet provides non-scheduled air service in response to a request of an owner. In recent years, in relation to the above-described sharing, there has been a demand for techniques that contribute to the widespread use of aircraft including small aircraft such as business jets.

An object of the present invention is to solve the above-mentioned problem.

According to a first aspect of the present invention, there is provided a management apparatus comprising a reservation acceptance unit configured to selectively accept an exclusive use reservation in which an aircraft is exclusively used by a sole reservation holder who has solely made a reservation for use of the aircraft, and a sharing reservation in which the aircraft is shared by a plurality of reservation holders; and a utilization plan formulation unit configured to formulate a utilization plan for the aircraft based on a result of acceptance by the reservation acceptance unit.

According to a second aspect of the present invention, there is provided a management method comprising a step in which a reservation acceptance unit selectively accepts one of an exclusive use reservation in which an aircraft is exclusively used by a sole reservation holder who has solely made a reservation for use of the aircraft, or a sharing reservation in which the aircraft is shared by a plurality of reservation holders; and a step in which a utilization plan formulation unit formulates a utilization plan for the aircraft based on a result of acceptance by the reservation acceptance unit.

According to a third aspect of the present invention, there is provided a non-transitory computer-readable storage medium that stores a program for causing a computer to execute a step of selectively accepting one of an exclusive use reservation in which an aircraft is exclusively used by a sole reservation holder who has solely made a reservation for use of the aircraft, or a sharing reservation in which the aircraft is shared by a plurality of reservation holders; and a step of formulating a utilization plan for the aircraft based on a result of acceptance of the reservation for use of the aircraft.

According to the present invention, it is possible to contribute to the widespread use of aircraft.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram illustrating a management system according to an embodiment; and

FIG. 2 is a flowchart illustrating a management method according to an embodiment.

### DETAILED DESCRIPTION OF THE INVENTION

### [Embodiment]

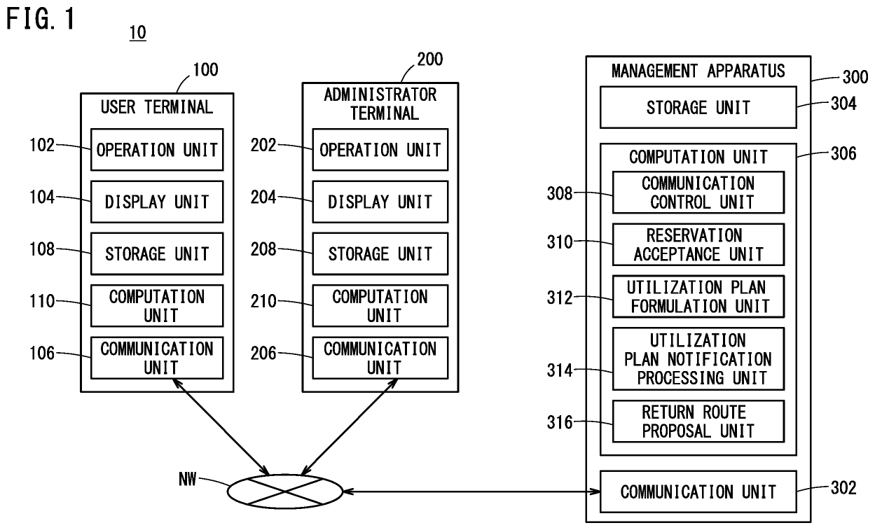

FIG. 1 is a block diagram illustrating a management system 10 according to the present embodiment.

The management system 10 is a system for managing the operation of an aircraft operated based on an operation route determined in advance. The aircraft is, for example, a small jet aircraft having a capacity of four to six passengers, but is not limited thereto. Although illustration of the aircraft is omitted, the aircraft is provided with a passenger compartment and a cargo compartment. The management system 10 includes a user terminal 100, an administrator terminal 200, and a management apparatus 300. The number of the user terminals 100 is not particularly limited. Therefore, a plurality of the user terminals 100 may be included in the management system 10.

The user terminal 100 is a terminal used by a user of the management system 10. The user terminal 100 is, for example, a smartphone, a tablet terminal, a personal computer (PC), or the like. The user terminal 100 includes an operation unit 102, a display unit 104, a communication unit 106, a storage unit 108, and a computation unit (control unit) 110.

The operation unit 102 receives an input operation performed by the user on the user terminal 100. The display unit 104 includes a display element (not illustrated). The display element is, for example, a liquid crystal display element, an organic electroluminescence display element, or the like. At least a part of the operation unit 102 and the display unit 104 may be constituted by a touch panel (not illustrated) provided with such a display element.

The communication unit 106 includes, for example, a communication module (not illustrated). The communication unit 106 is connected to a network NW. The network NW is, for example, the Internet.

The storage unit 108 may include a volatile memory (not illustrated) and a non-volatile memory (not illustrated). Examples of the volatile memory may include a random access memory (RAM). Examples of the non-volatile memory may include a read only memory (ROM) and a flash memory. At least a part of the storage unit 108 may be included in a processor, an integrated circuit, or the like, which will be described later.

The computation unit 110 may be constituted by a processor such as a central processing unit (CPU) or a graphics processing unit (GPU). That is, the computation unit 110 may be constituted by processing circuitry. The computation unit 110 controls the entire user terminal 100 based on a program stored in the storage unit 108. The computation unit 110 can control the user terminal 100 in accordance with an operation performed by the user using the operation unit 102. For example, the display unit 104 and the communication unit 106 described above are controlled by the computation unit 110. By the computation unit 110 controlling the display unit 104, for example, data stored in the storage unit 108 is appropriately displayed on the display unit 104. By the computation unit 110 controlling the communication unit 106, the user terminal 100 can communicate with the management apparatus 300 via the network NW.

The administrator terminal 200 is a terminal used by an administrator who manages the operation of the aircraft. The administrator is, for example, a person belonging to an operation management company that manages the operation of the aircraft. The administrator terminal 200 is, for example, a personal computer. However, the administrator terminal 200 may be a smartphone, a tablet terminal, or the like. The administrator terminal 200 includes an operation unit 202, a display unit 204, a communication unit 206, a storage unit 208, and a computation unit (control unit) 210.

The operation unit 202 receives an input operation performed by the administrator on the administrator terminal 200. The operation unit 202 is, for example, a keyboard, a mouse, or the like, but is not limited thereto. The display unit 204 includes a display element (not illustrated). The display element is, for example, a liquid crystal display element, an organic electroluminescence display element, or the like. At least a part of the operation unit 202 and the display unit 204 may be constituted by a touch panel (not illustrated) provided with such a display element.

The communication unit 206 includes, for example, a communication module (not illustrated). The communication unit 206 is connected to the network NW.

The storage unit 208 may include a volatile memory (not illustrated) and a non-volatile memory (not illustrated). Examples of the volatile memory may include a RAM and the like. Examples of the non-volatile memory may include a ROM, a flash memory, and the like. At least a part of the storage unit 208 may be included in a processor, an integrated circuit, or the like, which will be described later.

The computation unit 210 may be constituted by a processor such as a CPU or a GPU. That is, the computation unit 210 may be constituted by processing circuitry. The computation unit 210 can control the entire administrator terminal 200 based on a program stored in the storage unit 208. The computation unit 210 can control the administrator terminal 200 in accordance with an operation performed by the administrator using the operation unit 202. For example, the display unit 204 and the communication unit 206 described above are controlled by the computation unit 210. By the computation unit 210 controlling the display unit 204, for example, data stored in the storage unit 208 is appropriately displayed on the display unit 204. By the computation unit 210 controlling the communication unit 206, the administrator terminal 200 can communicate with the management apparatus 300 via the network NW.

The management apparatus 300 is a server apparatus (computer) for managing the operation of the aircraft. The management apparatus 300 is provided in, for example, a data center. The management apparatus 300 can communicate with the user terminal 100 and the administrator terminal 200 via the network NW. The management apparatus 300 includes a communication unit 302, a storage unit 304, and a computation unit 306.

The communication unit 302 includes, for example, a communication module (not illustrated). The communication unit 302 is connected to the network NW.

The storage unit 304 may include a volatile memory (not illustrated) and a non-volatile memory (not illustrated). Examples of the volatile memory may include a RAM and the like. Examples of the non-volatile memory may include a ROM, a flash memory, and the like. Data and the like can be stored in, for example, the volatile memory. Programs, tables, maps, and the like can be stored in, for example, the non-volatile memory. At least a part of the storage unit 304 may be included in a processor, an integrated circuit, or the like, which will be described later. In addition, the storage unit 304 may further include a hard disk drive (HDD), a solid state drive (SSD), or the like.

The storage unit 304 may store information indicating the operation route described above. Further, the storage unit 304 may store information related to the plurality of users described above. The storage unit 304 may store information indicating a utilization plan to be described later.

The computation unit 306 may be constituted by a processor such as a CPU or a GPU. That is, the computation unit 306 may be constituted by processing circuitry. The computation unit 306 includes a communication control unit 308, a reservation acceptance unit 310, a utilization plan formulation unit 312, a utilization plan notification processing unit 314, and a return route proposal unit 316.

The communication control unit 308, the reservation acceptance unit 310, the utilization plan formulation unit 312, the utilization plan notification processing unit 314, and the return route proposal unit 316 may be realized by the computation unit 306 executing a program stored in the storage unit 304. At least some of the communication control unit 308, the reservation acceptance unit 310, the utilization plan formulation unit 312, the utilization plan notification processing unit 314, and the return route proposal unit 316 may be realized by an integrated circuit such as an application specific integrated circuit (ASIC) or a field-programmable gate array (FPGA). Further, at least some of the communication control unit 308, the reservation acceptance unit 310, the utilization plan formulation unit 312, the utilization plan notification processing unit 314, and the return route proposal unit 316 may be constituted by an electronic circuit including a discrete device.

The communication control unit 308 controls the communication unit 302. As a result, the management apparatus 300 can communicate with the user terminal 100 via the network NW. Further, by the communication control unit 308 controlling the communication unit 302, the management apparatus 300 can communicate with the administrator terminal 200 via the network NW.

The reservation acceptance unit 310 accepts reservations for use of the aircraft from a plurality of users. As described above, the operation route on which the aircraft is operated is determined in advance. The operation route is determined in advance by the operation management company. A plurality of operation routes may be determined in advance. When the operation management company determines the operation route, it becomes easier for the operation management company to perform operation management as compared with the charter operation of the aircraft.

The user can use the user terminal 100 to perform a reservation procedure for reserving use of the aircraft. When a plurality of operation routes are determined in advance, the user can select any operation route.

In addition, the reservation acceptance unit 310 can selectively accept two types of reservations according to the user's desire. One of the two types of reservations is also referred to as an exclusive use reservation in the following description. The other of the two types of reservation is also referred to as a sharing reservation in the following description.

The exclusive use reservation is a reservation that provides a sole user with exclusive use of the aircraft within the range of the operation route. On the other hand, the sharing reservation is a reservation that provides a plurality of users with aircraft sharing within the range of the operation route. When a plurality of users share the aircraft, the operation cost of the aircraft borne by each user is easily reduced. In the following description, a user who has made a reservation for use of the aircraft is also referred to as a reservation holder. In addition, a user who has made the exclusive use reservation is also referred to as a sole reservation holder for distinction from the reservation holder who has made the sharing reservation.

The reservation acceptance unit 310 accepts reservation procedures made by users on a first-come-first-served basis within a reservation acceptance period. The reservation acceptance period is a predetermined period for inviting aircraft users.

When the reservation made by the user who has completed the reservation procedure earliest is the sharing reservation, the reservation acceptance unit 310 can continue to accept the sharing reservation made by a user other than the earliest user. As a result, a plurality of reservation holders who share the aircraft are acquired. As described above, the aircraft is provided with the passenger compartment and the cargo compartment. The aircraft sharing may include a mode in which the cargo compartment is used by a reservation holder different from a reservation holder who uses the passenger compartment. For example, at least one of the plurality of reservation holders may use the aircraft exclusively for transportation of supplies without boarding the aircraft. In addition, aircraft sharing may include a mode in which a temporary seat is used by a reservation holder different from a reservation holder who uses a seat stationarily installed in the aircraft.

When the reservation made by the user who has completed the reservation procedure earliest is the exclusive use reservation, the earliest user becomes the sole reservation holder. When the exclusive use reservation is accepted, the reservation acceptance unit 310 does not accept a reservation procedure made by a user other than the sole reservation holder of this exclusive use reservation. However, the reservation acceptance unit 310 may accept a procedure for changing from the exclusive use reservation to the sharing reservation. For example, as described above, when a plurality of reservation holders share the aircraft, the operation cost of the aircraft borne by each of the plurality of reservation holders can be reduced. The sole reservation holder can perform the procedure for changing from the exclusive use reservation to the sharing reservation, for example, in order to reduce the operation cost borne by this sole reservation holder. When the procedure for changing from the exclusive use reservation to the sharing reservation is performed, the reservation acceptance unit 310 resumes acceptance of the reservation (sharing reservation).

The utilization plan formulation unit 312 formulates the utilization plan for the aircraft based on the acceptance result of the reservation acceptance unit 310. The utilization plan includes, for example, information indicating the number of reservation holders. The utilization plan may include information indicating an operation cost to be borne by each reservation holder. In addition, when the sharing reservation is made, information indicating a usage mode of at least one of the passenger compartment or the cargo compartment provided in the aircraft may be included in the utilization plan. The information indicating the usage mode indicates, for example, whether or not a temporary seat is installed in the passenger compartment. Further, the information indicating the usage mode indicates, for example, whether or not the cargo compartment is used for transportation of supplies.

The utilization plan notification processing unit 314 performs a utilization plan notification process. The utilization plan notification process is process for providing notification of the utilization plan formulated by the utilization plan formulation unit 312. Accordingly, the utilization plan notification processing unit 314 can transmit information indicating the utilization plan formulated by the utilization plan formulation unit 312, to the administrator terminal 200. In addition, the utilization plan notification processing unit 314 can transmit the information indicating the utilization plan formulated by the utilization plan formulation unit 312, to the plurality of user terminals 100. The information indicating the utilization plan formulated by the utilization plan formulation unit 312 is appropriately transmitted from the management apparatus 300 to the plurality of user terminals 100 and the administrator terminal 200 via the network NW.

By transmitting the information indicating the utilization plan to the administrator terminal 200, the administrator who manages the operation of the aircraft can grasp the utilization plan formulated by the utilization plan formulation unit 312. As a result, the administrator can make preparations as necessary based on the utilization plan.

By transmitting the information indicating the utilization plan to the user terminals 100, the users can grasp the content of the utilization plan.

The return route proposal unit 316 proposes a return route after the reservation holder (sole reservation holder) moves using the aircraft. That is, the return route proposal unit 316 proposes a return route corresponding to an outward route accepted by the reservation acceptance unit 310. The return route proposal unit 316 proposes the return route based on the departure place and the arrival place that are based on the operation plan. The return route proposal unit 316 proposes, for example, but not limited to, a return route (air route) on which the aircraft is operated from the arrival place on the outward route to the departure place on the outward route. The return route proposal unit 316 may propose a return route (land route or the like) on which a transportation means other than an aircraft is operated. The return route proposal unit 316 may propose a plurality of return routes.

Information indicating the return route proposed by the return route proposal unit 316 is transmitted to the user terminal 100 from the management apparatus 300 via the network NW. The user terminal 100 is a terminal used by the reservation holder (sole reservation holder). By proposing the return route to the reservation holder, the reservation holder is provided with convenience.

In a case where the return route on which the aircraft is operated is proposed to the reservation holder by the return route proposal unit 316, the reservation acceptance unit 310 described above may accept a reservation for using the aircraft operated for the return route. As a result, the reservation holder is provided with further convenience. In addition, the widespread use of the aircraft is promoted.

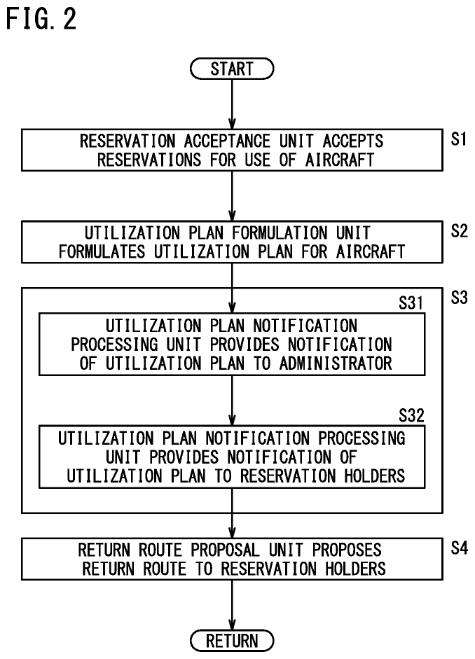

FIG. 2 is a flowchart illustrating a management method according to the present embodiment.

The management method according to the present embodiment is performed by, for example, the computation unit 306 provided in the management apparatus 300 executing a program stored in the storage unit 304. First, in step S1, the reservation acceptance unit 310 accepts reservations for use of the aircraft from users. The reservation acceptance unit 310 can selectively accept an exclusive use reservation and a sharing reservation.

Step S1 ends when a predetermined end condition is satisfied. The predetermined end condition is, for example, one of the following conditions: (1) the exclusive use reservation is established; (2) the above-described reservation acceptance period expires; and (3) the number of reservation holders of the sharing reservation reaches a specified number. The prescribed number described in (3) is set in advance.

As described above, there may be a case where the sole reservation holder desires to change the reservation from the exclusive use reservation to the sharing reservation. When the reservation made by the sole reservation holder is changed from the exclusive use reservation to the sharing reservation, step S1 may be resumed. However, in resumed step S1, acceptance of the exclusive use reservation can be restricted.

Next, the process proceeds to step S2, and the utilization plan formulation unit 312 formulates the utilization plan for the aircraft. The utilization plan formulation unit 312 formulates the utilization plan based on the acceptance result of the reservation acceptance unit 310.

Next, the process proceeds to step S3 (S31, S32), and the utilization plan notification processing unit 314 provides notification of the utilization plan. The utilization plan notification processing unit 314 provides notification of the utilization plan to the administrator who manages the operation of the aircraft (step S31). In addition, the utilization plan notification processing unit 314 provides notification of the utilization plan to the reservation holders (step S32).

Next, the process proceeds to step S4, and the return route proposal unit 316 proposes a return route to the reservation holder. Note that the return route proposal unit 316 may propose the return route to the reservation holder only when the reservation holder desires. When the reservation holder does not want the return route proposal unit 316 to propose the return route, step S4 may be skipped. Thus, the management method illustrated in FIG. 2 ends.

According to the present embodiment, whether an aircraft is exclusively used by a sole user or the aircraft is shared by a plurality of users is determined according to a user's desire. To a user who wishes to exclusively use the aircraft, it is possible to provide a service close to that provided by a business jet, as compared with a general passenger aircraft. Further, as described above, the operation route of the aircraft is determined in advance by the operation management company. As a result, it is possible to suppress the cost required for the transit of the aircraft, as compared with a business jet for which the departure place and the arrival place are determined according to a request of an owner. In addition, when the aircraft is shared by a plurality of users, the cost borne by each of the plurality of users is further suppressed. In this way, the management system 10 according to the present embodiment can contribute to the widespread use of the aircraft.

### [Modified Embodiment]

In the above-described embodiment, the reservation acceptance unit 310 accepts reservations for use of the aircraft on a first-come-first-served basis, but the present invention is not limited thereto. The reservation acceptance unit 310 may select a reservation holder from among a plurality of users who have performed the reservation procedure. For example, the reservation acceptance unit 310 may select a sole user who has performed the reservation procedure for the exclusive use reservation, from among the plurality of users who have performed the reservation procedure. The reservation acceptance unit 310 accepts a use reservation made by the selected sole user. In addition, the reservation acceptance unit 310 may select a plurality of users to establish the sharing reservation, from among the plurality of users who have performed the reservation procedure. The plurality of users to establish the sharing reservation are selected, for example, within the range of the prescribed number described above. The reservation acceptance unit 310 may select a reservation holder by lottery.

The reservation acceptance unit 310 may select a reservation holder in the following manner, for example, instead of the lottery. That is, the reservation acceptance unit 310 may preferentially accept a use reservation made by a user who satisfies a predetermined condition. The predetermined condition is, for example, that the user has made a reservation for using a predetermined moving object after using the aircraft. The predetermined moving object is, for example, a vehicle operated for users of the business jet. Specific examples of the vehicle include, but are not limited to, a taxi, an airport limousine, chauffeur service, and the like that are dispatched in an airport so that passengers who have got off the aircraft can quickly use the vehicle. By preferentially selecting an applicant for use of the aircraft who has reserved the use of such a moving object, it makes easier for the applicant to feel a sense of satisfaction that is difficult to obtain when using a general passenger aircraft.

[Inventions Grasped from Embodiments]

The inventions that can be grasped from the above-described embodiments will be described below.

(1) The management apparatus (300) includes: the reservation acceptance unit (310) configured to selectively accept an exclusive use reservation in which an aircraft is exclusively used by a sole reservation holder who has solely made a reservation for use of the aircraft, and a sharing reservation in which the aircraft is shared by a plurality of reservation holders; and the utilization plan formulation unit (312) configured to formulate a utilization plan for the aircraft based on the result of acceptance by the reservation acceptance unit. According to this feature, it is possible to contribute to the widespread use of the aircraft.

(2) In the above-described management apparatus, sharing the aircraft may include a mode in which a cargo compartment is used by a reservation holder among the reservation holders who is different from a reservation holder among the reservation holders who uses a passenger compartment, the cargo compartment and the passenger compartment being provided in the aircraft. According to this feature, the convenience of the aircraft is provided to even a reservation holder who does not board the aircraft.

(3) In the above-described management apparatus, sharing the aircraft may include a mode in which a temporary seat is used by a reservation holder among the reservation holders who is different from a reservation holder among the reservation holders who uses a seat stationarily installed in the aircraft. According to this feature, the convenience of the aircraft is provided to even more users.

(4) The above-described management apparatus may further include the return route proposal unit (316) configured to propose a return route corresponding to an outward route accepted by the reservation acceptance unit. According to this feature, the reservation holder is provided with convenience.

(5) In the above-described management apparatus, the return route proposal unit may propose, as the return route, a return route on which the aircraft is operated from an arrival place on the outward route to a departure place on the outward route. According to this feature, the convenience of the aircraft can be provided to the user also on the return route. As a result, the widespread use of the aircraft is further promoted.

(6) In the above-described management apparatus, the reservation acceptance unit may preferentially accept a reservation made by a person who has made a reservation for using a predetermined moving object after using the aircraft. According to this feature, it makes easier for the reservation holder to feel a sense of satisfaction that is difficult to obtain when using a general passenger aircraft.

(7) The management method includes: the step (S1) in which the reservation acceptance unit (310) selectively accepts one of an exclusive use reservation in which an aircraft is exclusively used by a sole reservation holder who has solely made a reservation for use of the aircraft, or a sharing reservation in which the aircraft is shared by a plurality of reservation holders; and the step (S2) in which the utilization plan formulation unit (312) formulates a utilization plan for the aircraft based on the result of acceptance by the reservation acceptance unit. According to this feature, it is possible to contribute to the widespread use of the aircraft.

(8) The non-transitory computer-readable storage medium stores a program, and the program causes a computer to execute: the step (S1) of selectively accepting one of an exclusive use reservation in which an aircraft is exclusively used by a sole reservation holder who has solely made a reservation for use of the aircraft, or a sharing reservation in which the aircraft is shared by a plurality of reservation holders; and the step (S2) of formulating a utilization plan for the aircraft based on the result of acceptance of the reservation for use of the aircraft. According to this feature, it is possible to contribute to the widespread use of the aircraft.

It should be noted that the present invention is not limited to the disclosure described above, and various configurations can be adopted therein without departing from the essence and gist of the present invention.

1. A management apparatus comprising one or more processors that execute computer-executable instructions stored in a memory,
wherein the one or more processors execute the computer-executable instructions to cause the management apparatus to:
selectively accept an exclusive use reservation in which an aircraft is exclusively used by a sole reservation holder who has solely made a reservation for use of the aircraft, and a sharing reservation in which the aircraft is shared by a plurality of reservation holders who each have made a reservation for use of the aircraft; and
formulate a utilization plan for the aircraft based on a result of acceptance of the reservation for use of the aircraft.

2. The management apparatus according to claim 1, wherein
sharing the aircraft includes a mode in which a cargo compartment is used by a reservation holder among the reservation holders who is different from a reservation holder among the reservation holders who uses a passenger compartment, the cargo compartment and the passenger compartment being provided in the aircraft.

3. The management apparatus according to claim 1, wherein
sharing the aircraft includes a mode in which a temporary seat is used by a reservation holder among the reservation holders who is different from a reservation holder among the reservation holders who uses a seat stationarily installed in the aircraft.

4. The management apparatus according to claim 1, wherein
the one or more processors cause the management apparatus to propose a return route corresponding to an outward route that has been accepted by the management apparatus.

5. The management apparatus according to claim 4, wherein
the one or more processors cause the management apparatus to propose, as the return route, a return route on which the aircraft is operated from an arrival place on the outward route to a departure place on the outward route.

6. The management apparatus according to claim 1, wherein
the one or more processors cause the management apparatus to preferentially accept a reservation made by a person who has made a reservation for using a predetermined moving object after using the aircraft.

7. A management method executed by one or more processors, the management method comprising:
selectively accepting one of an exclusive use reservation in which an aircraft is exclusively used by a sole reservation holder who has solely made a reservation for use of the aircraft, or a sharing reservation in which the aircraft is shared by a plurality of reservation holders who each have made a reservation for use of the aircraft; and
formulating a utilization plan for the aircraft based on a result of acceptance of the reservation for use of the aircraft.

8. A non-transitory computer-readable storage medium that stores a program, the program causing a computer to execute:
selectively accepting one of an exclusive use reservation in which an aircraft is exclusively used by a sole reservation holder who has solely made a reservation for use of the aircraft, or a sharing reservation in which the aircraft is shared by a plurality of reservation holders who each have made a reservation for use of the aircraft; and
formulating a utilization plan for the aircraft based on a result of acceptance of the reservation for use of the aircraft.
